(19) United States
(12) Patent Application Publication
(10) Pub. No.: US 2025/0355876 A1
(43) Pub. Date: Nov. 20, 2025

(54) PROFILING DATABASE STATEMENTS

(71) Applicant: Salesforce, Inc., San Francisco, CA (US)

(72) Inventors: Rui Zhang, Fremont, CA (US); Prateek Swamy, Livermore, CA (US)

(21) Appl. No.: 18/668,805

(22) Filed: May 20, 2024

(51) Int. Cl. G06F 16/2453; G06F 11/34; G06F 16/2452

(52) U.S. Cl. CPC G06F 16/24545; G06F 11/3419; G06F 16/24526

(57) ABSTRACT

Techniques are disclosed that pertain to profiling database statement execution. A computer system receives a request to profile the execution of a database statement by a database process. The request specifies a process identifier (ID) associated with the database process. The computer system initializes a profiling process to establish a profiling session in which the profiling process profiles the execution of the database statement to generate profiling results that identify a set of performances metrics associated with the execution of the database statement. The process ID is provided to the profiling process to establish the profiling session. The computer system detects an occurrence of a trigger event indicating that the profiling process should be terminated. The computer system terminates the profiling process in response to the occurrence of the trigger event. The profiling results may be stored in a storage repository accessible to the computer system.

### BACKGROUND

### Technical Field

This disclosure relates generally to database systems and, more specifically, to various mechanisms for profiling database statements.

### Description of the Related Art

Database management systems (or, simply “database systems”) enable users to store data in an organized manner that can be efficiently accessed and manipulated. During its operation, a database system can receive requests from users via applications or from other systems, such as another database system, to perform database transactions on the data that is stored in a database of the database system. As part of facilitating these database transactions, the database system includes database processes that execute database statements to store, retrieve, and manipulate data in the database. Understanding the performance characteristics of the execution of the database statements by these processes can be important in developing effective solutions and improvements to the database system.

### BRIEF DESCRIPTION OF THE DRAWINGS

FIG. 1 is a block diagram illustrating example elements of a system that includes a profiler orchestrator process that can initialize performance profiler processes to profile the execution of database statements by backend processes, according to some embodiments.

FIG. 2A is a block diagram illustrating example elements of a database engine that can generate execution plans based on profiler configurations, according to some embodiments.

FIG. 2B is a block diagram illustrating example elements of a profiler configuration, according to some embodiments.

FIG. 3 is a block diagram illustrating example elements of a backend process causing the execution of a database statement to be profiled, according to some embodiments.

FIG. 4 is a block diagram illustrating example elements of a profiler orchestrator process initializing a performance profiler process to profile the execution of a database statement, according to some embodiments.

FIG. 5 is a block diagram illustrating example elements of a profile mapping that maps performance profiler processes to backend processes, according to some embodiments.

FIG. 6 is a block diagram illustrating example elements of a performance report for a profiling session, according to some embodiments.

FIGS. 7 and 8 are flow diagrams illustrating example methods relating to profiling the execution of a database statement, according to some embodiments.

FIG. 9 is a block diagram illustrating elements of a computer system for implementing various systems described in the present disclosure, according to some embodiments.

### DETAILED DESCRIPTION

Enterprises routinely implement database systems that enable users to store data in an organized manner that can be efficiently accessed and manipulated. During its operation, a database system can receive and process a substantial number of database statements, such as Structured Query Language (SQL) statements, to store, manipulate, and/or read data of a database. For example, a database process may execute an SQL SELECT statement to select and return one or more rows from one or more tables. In some cases, the execution of these database statements runs slower than expected and causes bottlenecks that can affect the performance of the database system. Identifying the source of these bottlenecks can be an important step in improving the operation of the database system.

One conventional approach to tracking the performance of a statement execution is to use timers to track the execution time of database statements and functions. But there are caveats with this approach. First, manually adding timers to various sections of code is labor and time intensive. Second, because a database process may call multiple functions during the execution of a database statement, it can be difficult to determine which particular function caused the slowdown. Third, employing timers requires frequently calling costly time-obtaining routines that can cause performance degradation of the database processes, especially when executing a large number of database statements. Thus, this conventional approach is deficient. Another conventional approach to analyzing program performance is through runtime profiling using a profiling tool, such as perf. But this approach requires manual intervention by running the perf profile command and stopping it after a profile has been collected. As a result, this approach is not a viable option in profiling programs running in the cloud at scale. Accordingly, this disclosure addresses, among other things, the technical problem of how to track the performance (e.g., time and resource consumption metrics) of the execution of a database statement in a manner that may overcome some or all of the above-described deficiencies.

In various embodiments that are described below, a database system implements a profiler orchestrator process that can initialize and manage profiling processes that profile the execution of database statements by database processes. In order to profile the execution of a database statement, a user may create an entry that specifies profiling parameters associated with the database statement, such as its statement ID. As a result, the database system may compile or recompile a query plan for that database statement to enable profiling. When a request to execute the database statement is received, a database process (also referred to as a “backend process”) may execute that database statement in accordance with the query plan. But prior to executing the database statement, in various embodiments, the database process sends a start request to the profiler orchestrator process to start profiling the execution of the database statement. The database process may delay execution of the database statement for a period of time to allow a profiling session to be established. In response to receiving the start request, the profiler orchestrator process instantiates a profiling process that profiles the execution of the database statement. As a part of profiling the database statement execution, the profiling process writes profiling results to a directory—the results may be written when the profiling session terminates. These profiling results can include a call stack, performance metrics of the call stack, execution time for the call stack, values of a large variety of hardware and software counters, and/or execution frequency. After executing the database statement, the database process may send a stop request to the profiler orchestrator process to terminate the profiling process (or the profiling process may terminate after a period of time). After receiving the stop request, the profiler orchestrator process then terminates the profiling process.

These techniques may be advantageous over prior approaches as these techniques allow for the automatic collection of performance profiles for one or more database processes executing database statements. The profiling process can collect a granular level of detail that describes the execution of a database statement that allows developers to determine which function(s) are causing a slowdown. For example, a performance profile may include a call stack with execution times that indicate a particular function is causing the slowdown. Also, since the profiling is conducted by a profiling process that is distinct from a database process, issues with the profiling process do not degrade the performance of the database process and the profiling process also does not inherit properties (e.g., global states) from the database process—the profiling process is not exposed to data that it should not observe and may not pose a security risk to the database process. Moreover, since timers do not have to be inserted into code (executed by a database process) to track the performance, the database process does not suffer performance degradation from starting and stopping timers and writing out their results.

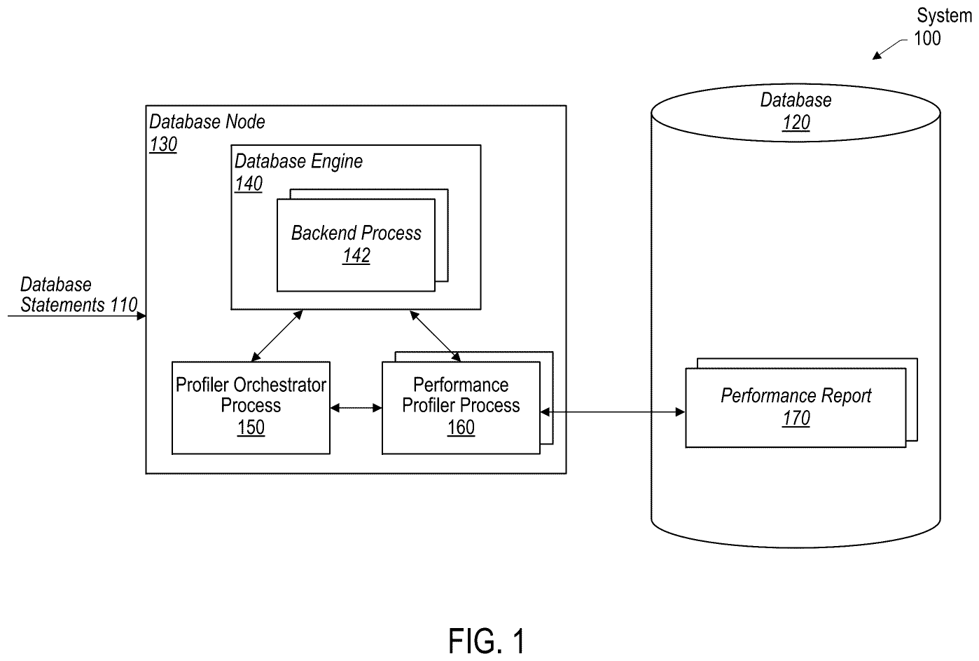

Turning now to FIG. 1, a block diagram of system 100 is shown. System 100 includes a set of components that may be implemented via hardware or a combination of hardware and software. In the illustrated embodiment, system 100 includes a database 120 and a database node 130. As further depicted, database 120 includes performance reports 170, and database node 130 includes a database engine 140 (with backend processes 142), a profiler orchestrator process 150, and performance profiler processes 160. In some embodiments, system 100 is implemented differently than shown. For example, database engine 140 and processes 150 and 160 may be implemented by different nodes or profile orchestrator process 150 and/or performance profiler processes 160 may be part of database engine 140. Further, the number of components of system 100 may vary between embodiments. Thus, there can be more or fewer of each component than the number shown in FIG. 1—e.g., there may be a single performance profiler processes 160.

System 100, in various embodiments, implements a platform service (e.g., a customer relationship management (CRM) platform service) that allows users of the service to develop, run, and manage applications. System 100 may be a multi-tenant system that provides various functionality to users/tenants hosted by the multi-tenant system. As such, system 100 may execute software routines from various, different users (e.g., providers and tenants of system 100) as well as provide code, web pages, and other data to users, databases, and other entities that are associated with system 100. In various embodiments, system 100 is implemented using cloud infrastructure that is provided by a cloud provider. Accordingly, database 120, database node 130, backend processes 142, profiler orchestrator process 150, and/or performance profiler processes 160 may use the available cloud resources of the cloud infrastructure (e.g., computing resources, storage resources, etc.) in order to facilitate their operation. For example, program code executable to implement processes of database node 130 may be stored on a non-transitory computer-readable medium of server-based hardware included in a datacenter of the cloud provider and executed in a virtual machine hosted on that hardware. In some cases, components of system 100 may execute on a computing system of the cloud infrastructure without the assistance of a virtual machine or certain deployment technologies, such as containerization. In some embodiments, system 100 is implemented using local or private infrastructure as opposed to a public cloud.

Database 120, in various embodiments, is a collection of information that is organized in a manner that allows for access, storage, and/or manipulation of that information. Database 120 may include supporting software (e.g., storage servers) that enables database node 130 to carry out those operations (e.g., accessing, storing, etc.) on the information stored at database 120. In various embodiments, database 120 is implemented using a single or multiple storage devices that are connected together on a network (e.g., a storage attached network (SAN)) and configured to redundantly store information in order to prevent data loss. The storage devices may store data persistently and thus database 120 may serve as a persistent storage for system 100. Further, as discussed, components of system 100 may use the available cloud resources of cloud infrastructure. Accordingly, the data of database 120 may be stored using a storage service provided by a cloud provider (e.g., Amazon S3®). In various embodiments, data written to database 120 by database node 130 is accessible to other database nodes 130 in a multi-node configuration.

Database node 130, in various embodiments, provides database services, such as data storage, data retrieval, and data manipulation of data of database 120. In some embodiments, database node 130 is implemented on a virtual machine (e.g., one deployed onto resources of a cloud infrastructure). Accordingly, components (e.g., database engine 140) of database node 130 may execute within a virtual machine. But in some embodiments, database node 130 is a physical computing device (e.g., server hardware) on which its components can be deployed or otherwise installed. In various embodiments, the software executing on database node 130 can interact with software executing on another node. For example, a process (e.g., a performance profiler process 160) executing on a first node may communicate with another process (e.g., a backend process 142) that is executing on a second node in order to generate a performance report 170.

Database engine 140 (alternatively referred to as a “database application”), in various embodiments, is executable software that provides the various database services of database node 130. These database services may be provided to other components in system 100 or to components external to system 100. For example, database engine 140 may receive a request from an application node to perform a database transaction for database 120. A database transaction, in various embodiments, is a logical unit of work (e.g., a specified set of database operations) to be performed in relation to database 120. Accordingly, performing a database transaction by database engine 140 may include executing one or more database statements 110. For example, executing a database transaction may include executing an SQL SELECT statement to select and return one or more rows from one or more tables. The contents of a row may be specified in a record stored at database 120 and thus database engine 140 may return, to the issuer of the request, records from database 120. In order to process database transactions, database engine 140 manages and executes backend processes 142.

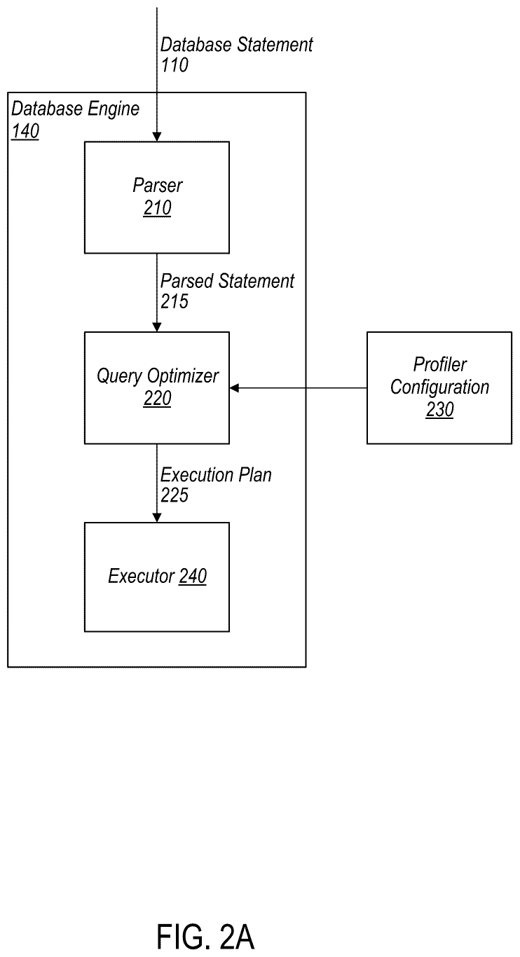

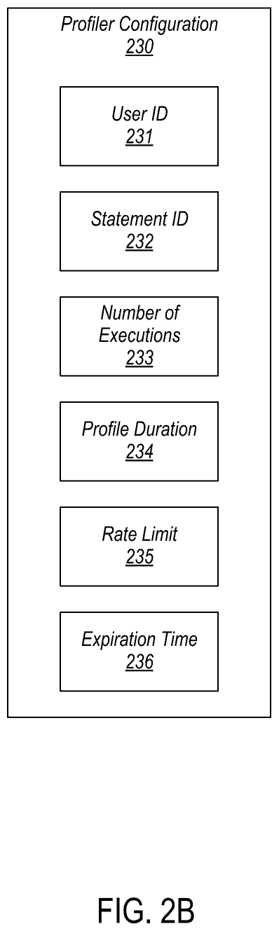

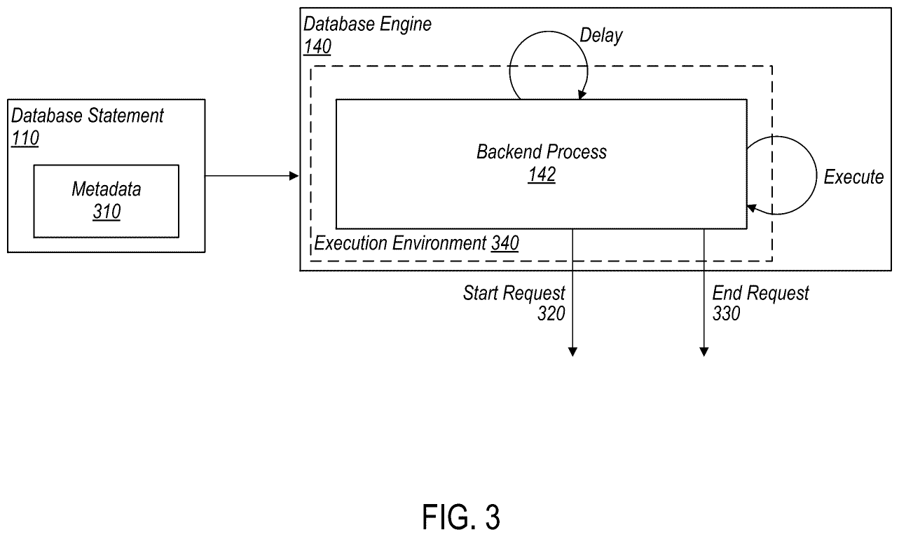

Backend processes 142, in various embodiments, are processes that execute database statements 110 in accordance with query execution plans. A query execution plan, in various embodiments, is a sequence of steps, compiled by a query optimizer of database engine 140, that a backend process 142 implements to execute a database statement 110. When database engine 140 receives a database statement 110, it may parse it and compile a query execution plan based on the parsing and in accordance with a set of parameters defined by a profiler configuration. In various embodiments, the profiler configuration specifies parameters that affect the profiling of a particular database statement 110, such as the number of executions to be profiled, the length of time of the profiling sessions, etc. In some cases, database engine 140 generates multiple query execution plans and executes one of them in a single execution flow (e.g., triggered by a request to execute an associated database statement 110). Also, in some cases, database engine 140 receives a request to generate a query execution plan for a database statement 110 and separately receives a request to execute that database statement 110. In other cases, database engine 140 receives a request to execute a database statement 110 and then generates a query plan in preparation to execute that database statement 110. The query optimizer and profiler configuration are discussed in greater detail with respect to FIG. 2A. In various embodiments, a query execution plan (for a database statement 110 that is being profiled) causes a backend process 142 to send a profiling/start request to profiler orchestrator process 150 prior to executing the database statement 110. In particular, a user can specify the intention of profiling that database statement 110. In various embodiments, the information to perform profiling is stored in the current database process 142 and thus, when this process 142 starts executing that database statement 110, the process 142 sends a profiling request to profiler orchestrator process 150. Backend processes 142 are discussed in greater detail with respect to FIG. 3.

Profiler orchestrator process 150, in various embodiments, is a process that spawns and manages performance profiler processes 160 that profile the execution of database statements 110 by backend processes 142. In response to receiving a profiling/start request from a backend process 142, profiler orchestrator process 150 forks a performance profiler process 160 as a child process. Performance profiler process 160, in various embodiments, is a process that executes a profiling command to profile a backend process 142 as it executes a database statement 110. For example, a performance profiler process 160 may execute the profiling command to profile a backend process 142 as it executes a SELECT statement.

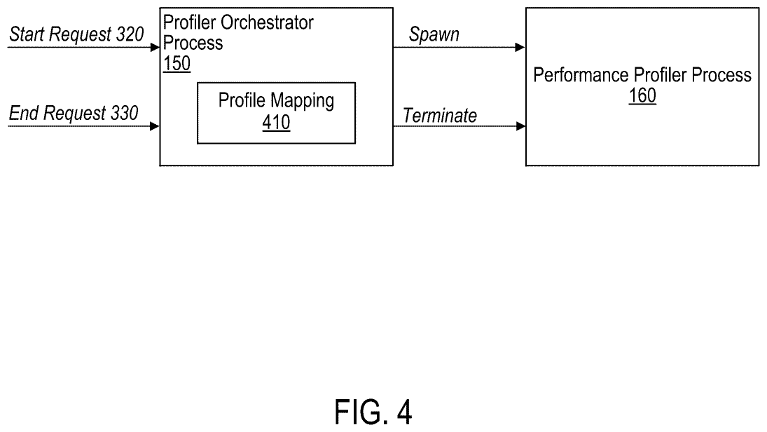

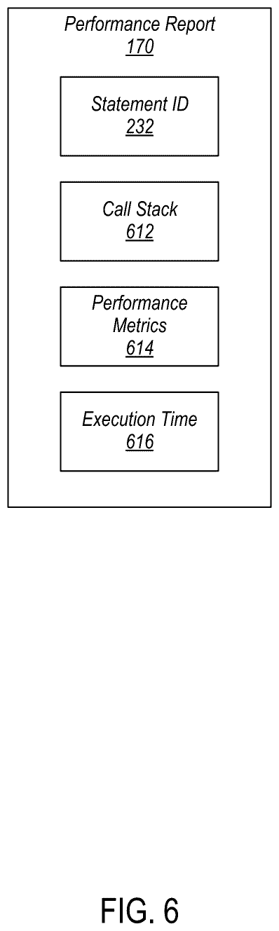

After a backend process 142 has finished executing a database statement 110, it may send a termination request to profiler orchestrator process 150. Profiler orchestrator process 150 may identify the performance profiler process 160 associated with the termination request based on a profiling mapping and then terminate that performance profiler process 160. Prior to terminating, in various embodiments, the performance profiler process 160 generates a performance report 170. A performance report 170, in various embodiments, is a record of the performance data collected during the execution of a database statement 110. For example, a performance profiler process 160 may profile the execution of a DELETE statement by a backend process 142 and generate and store a performance report 170 having performance metrics describing the execution of that statement. A performance report 170 is discussed in greater detail with respect to FIG. 6. Also, profiler orchestrator process 150 and performance profiler processes 160 are discussed in greater detail with respect to FIG. 4.

Turning now to FIG. 2A, a block diagram of database engine 140 creating an execution plan 225 based on a profiler configuration 230 is shown. In the illustrated embodiment, there is database engine 140 and profiler configuration 230. As further shown, database engine 140 includes a parser 210, a query optimizer 220, and an executor 240 that is implemented by a backend process 142. In some embodiments, the process for generating execution plan 225 is implemented differently than shown.

As shown in the illustrated embodiment, parser 210 receives a database statement 110. Parser 210, in various embodiments, parses database statement 110, resulting in a parsed statement 215. In some embodiments, this parsing may include performing a syntax analysis of the clauses within database statement 110 and assembling a data structure (e.g., an expression tree) that can be processed by query optimizer 220. For example, parser 210 may construct an abstract syntax tree in which the nodes represent the statement sequence. In the illustrated embodiment, parser 210 provides parsed statement 215 to query optimizer 220.

Query optimizer 220, in various embodiments, generates execution plan 225 for database statement 110, which can include evaluating various execution plans 225 and selecting one to implement. Execution plan 225, in various embodiments, is a sequence of steps that backend process 142 performs to execute database statement 110. Optimizer 220 may use any suitable algorithm to evaluate and select plans 225. In some embodiments, optimizer 220 uses a heuristic algorithm in which execution plans 225 are assessed based on a set of rules provided to optimizer 220. In other embodiments, optimizer 220 uses a cost-based algorithm in which optimizer 220 performs a cost analysis that includes assigning scores to execution plans 225 based on an estimated processor consumption, an estimated memory consumption, an estimated execution time, etc. These estimates may further be based on various metrics such as the number of distinct values in table columns, the selectivity of predicates (the fraction of rows the predicate would qualify), the cardinalities (e.g., row counts) of tables, etc. Based on the assigned scores, optimizer 220 may then select the particular execution plan 225 having the best score. In still other embodiments, optimizer 220 may use a combination of heuristic and cost-based algorithms.

Query optimizer 220, in various embodiments, can further insert information into execution plan 225 based on profiler configuration 230. Profiler configuration 230, in various embodiments, specifies a set of parameters for performing a profiling operation of database statement 110. As an example, profiler configuration 230 may specify a particular statement ID that causes query optimizer 220 to inject commands into a particular execution plan 225 to profile the execution of a database statement 110 associated with the particular statement ID. Profiler configuration 230 is discussed in greater detail with respect to FIG. 2B. In some embodiments, when execution plan 255 has been generated by query optimizer 220, it may provide execution plan 225 to a cache in addition to providing execution plan 225 to executor 240. The cache, in various embodiments, maintains previously determined execution plans 225 for statements 110 so that they can be reused if those database statements 110 are received again-thus saving the effort of having to regenerate execution plans 225.

When execution plan 225 has been provided to executor 240 (which is implemented by a backend process 142), executor 240 may execute execution plan 225. Accordingly, the backend process 142 implementing executor 240 may perform the various actions defined in plan 225, which may include sending a profiling/start request to profiler orchestrator process 150.

Turning now to FIG. 2B, a block diagram of an example profiler configuration 230 is shown. In the illustrated embodiment, profiler configuration 230 includes a user ID 231, a statement ID 232, a number of executions 233, a profile duration 234, a rate limit, 235, and an expiration time 236. Profiler configuration 230 may be implemented differently than shown. For example, profiler configuration 230 may specify a statement type instead of statement ID 232.

As discussed, profiler configuration 230 defines one or more parameters for profiling a respective database statement 110. Profile configuration 230 may be provided prior to requesting the execution of the respective statement 110 or in a request to execute that respective statement 110. In some embodiments, profiler configuration 230 is specified by users via data manipulation language (DML) statements. For example, a user may use an INSERT statement to specify a value for a particular parameter of profiler configuration 230. In some embodiments, default parameters are included without user input. For example, profile duration 234 may include a default value of ten seconds. Profiler configuration 230 may include multiple entries for profiling multiple database statements 110.

User ID 231, in various embodiments, is a unique identifier associated with a user or tenant of system 100 and can be represented as a sequence of characters. In some cases, user ID 231 identifies a tenant and a user of the tenant. Statement ID 232, in various embodiments, is a unique identifier associated with a database statement 110 and can also be a sequence of characters. User ID 231 and statement ID 232 may be used together to identify a particular statement 110 to profile. For example, profiler configuration 230 may specify a user ID 231 for a user A of a tenant A and a statement ID 232 for a database statement A. Accordingly, query optimizer 220 may create or modify an execution plan 225 for database statement A of user A of tenant A so that it is profiled during execution. Instead of specifying a statement ID, in some embodiments, profiler configuration 230 specifies a statement type (e.g., INSERT) and thus query optimizer 220 may create or modify execution plans 225 for statements 110 of that type so that they are profiled during execution.

Number of executions 233, in various embodiments, is a value indicating the number of executions of a given statement 110 to profile. As an example, profiler configuration 230 may specify a value of five for a particular database statement 110, and as a result, a backend process 142 may send profiling requests to profiler orchestrator process 150 for the next five executions of that database statement 110. When creating an execution plan 225 for a given statement 110, query optimizer 220 may indicate, in that plan 225 (or at another location), the number of times to profile that given statement 110. After a database statement 110 has been profiled for the specified number of executions 223, in various embodiments, the execution plan 225 corresponding to that database statement 110 may be invalidated and/or removed by database engine 140. In some cases, database engine 140 recompiles that execution plan 225 such that the database statement 110 is not profiled the next time that a backend process 142 executes it.

Profile duration 234, in various embodiments, a time value indicating how long a performance profiler process 160 is instructed to profile a particular database statement 110. For example, a performance profiler process 160 may profile the execution of an SQL FETCH statement for five seconds regardless of whether the execution of the SQL FETCH statement is complete after those five seconds. In some embodiments, profiler configuration 230 specifies a default value for profile duration 234 (e.g., terminate a performance profiler process 160 after ten seconds).

Rate limit 235, in various embodiments, is a value for rate limiting the number of profiling sessions for a database statement 110 within a time period. For example, rate limit 235 may limit the number of profiling sessions for a particular statement 110 within a 24-hour period. In some embodiments, rate limit 235 is specified at the user/tenant level such that the collective number of profiling sessions for a user/tenant does not exceed a threshold within a time period. For example, rate limit 235 may limit the number of profiling sessions for a tenant to a hundred in an hour period. In some embodiments, rate limit 235 defines a value for rate limiting the number of concurrent profiling sessions for a database statement 110. For example, rate limit 235 may limit the number of concurrent profiling sessions such that only five concurrent executions of a particular database statement 110 are profiled at a given time.

Expiration time 236, in various embodiments, is a time value indicating when profiler configuration 230 expires. For example, expiration time 236 may specify five hours, and thus profiler configuration 230 expires after five hours. Profile configuration 230 may be invalidated and/or removed by database engine 140 after expiration time 236 is satisfied. Similarly, a cached plan 225 may be invalidated and/or removed by database engine 140 after expiration time 236 is satisfied.

Turning now to FIG. 3, a block diagram illustrating a backend process 142 sending a start request 320 (also referred to as a profiling request) and an end request 330 (also referred to as a termination request) is shown. In the illustrated embodiment, there is a database statement 110 and database engine 140. As further shown, database statement 110 includes metadata 310, and database engine 140 includes a backend process 142. In some embodiments, the depicted approach is implemented differently than shown. For example, backend process 142 may not send an end request 330 to profiler orchestrator process 150.

As shown, database engine 140 receives database statement 110 with metadata 310. Metadata 310, in various embodiments, is metadata associated with database statement 110, which may include its statement ID, user/tenant information (e.g., user ID 231), its type, etc. After receiving database statement 110, backend process 142 may obtain an execution plan 225 for database statement 110 based on metadata 310 (e.g., one matching its statement ID). The execution plan 225 may be stored in a cache and thus backend process 142 may access it from that cache. If there is no existing execution plan 225 for database statement 110, then query optimizer 220 may create the execution plan 225. After part of creating that execution plan 225, query optimizer 220 may determine that database statement 110 matches a profiler configuration 230 and thus query optimizer 220 may incorporate additional information in an execution environment 340 of backend process 142 via the execution plan 225, which triggers executor 240 in backend process 142 to request that database statement 110 be profiled during its execution. For example, if the statement ID for database statement 110 matches a statement ID 232 specified by a profiler configuration 230, then query optimizer 220 may incorporate the additional information into a particular execution environment 340 associated with database statement 110. Execution environment 340, in various embodiments, encompasses the global variables that are needed to run executor 240. Query optimizer 220 may then provide that execution plan 225 to backend process 142.

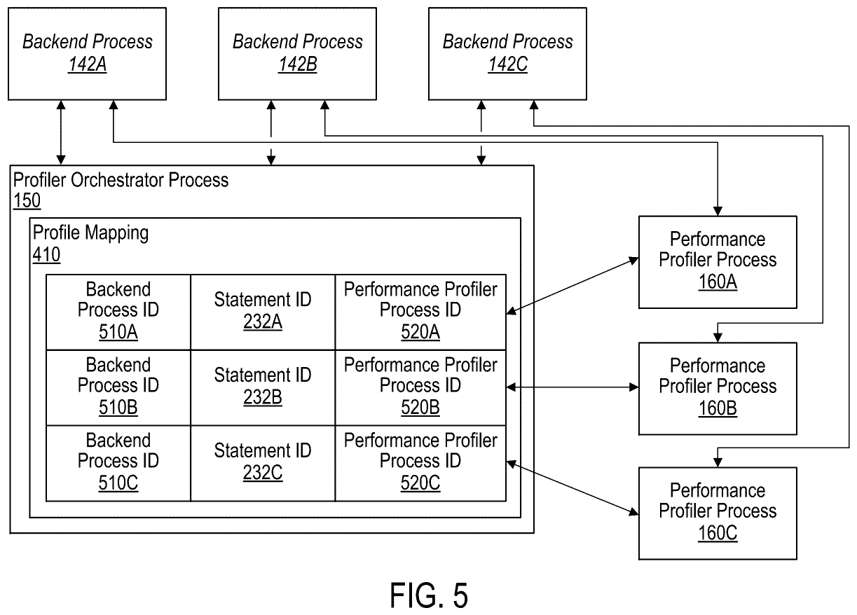

Prior to executing database statement 110, backend process 142 sends start request 320 to profiler orchestrator process 150. Start request 320, in various embodiments, is a request to initiate a profiling session to profile the execution of database statement 110 by backend process 142. In some embodiments, start request 320 includes parameters from the associated profiler configuration 230, such as a profile duration 234. For example, start request 325 may instruct profiler orchestrator process 150 to terminate a performance profiler process 160 after ten seconds. Start request 320 may also include at least a portion of metadata 310 (e.g., the statement ID of statement 110) and/or metadata associated with backend process 142 that allows profiler orchestrator process 150 to maintain a mapping between performance profiler processes 160 instantiated by profiler orchestrator process 150 and backend processes 142. For example, profiler orchestrator process 150 may map a performance profiler process 160 to backend process 142 based on the process ID of backend process 142 assigned by an operating system or the backend ID of backend process 142 assigned by database engine 140. The profile mapping is discussed in greater detail with respect to FIGS. 4 and 5.

After sending start request 320, backend process 142 delays/defers the execution of database statement 110 for a period of time until one or more criteria is satisfied. The criteria may include satisfying a time value threshold, receiving a response from profiler orchestrator process 150 or a performance profiler process 160, detecting the creation of the performance profiler process 160, detecting that a profiling session has started, etc. For example, query optimizer 220 may add a delay step to plan 225 that causes backend process 142 to delay executing statement 110 for one second to allow the profiling session to start. As another example, backend process 142 may delay until the performance profiler process 160 sends a ready response to backend process 142, causing it to proceed to execute statement 110. In some embodiments, backend process 142 executes statement 110 after sending start request 320 without intentionally delaying.

In response to one or more criteria being satisfied, backend process 142 executes statement 110. After executing statement 110, backend process 142 sends end request 330 to profiler orchestrator process 150. End request 330, in various embodiments, is a request to end the profiling session and terminate the performance profiler process 160. In some embodiments, backend process 142 sends end request 330 to the performance profiler process 160 to cause it to terminate itself. In some cases, backend process 142 may not send end request 330 as profiler orchestrator process 150 may terminate the performance profiler process 160 (or the performance profiler process 160 may terminate itself) in accordance with a specified profile duration 234 without receiving end request 330, or it may receive end request 330 but ignore it.

Turning now to FIG. 4, a block diagram illustrating example interactions between profile orchestrator process 150 and a performance profiler process 160 is shown. In the illustrated embodiment, there is profiler orchestrator process 150 and a performance profiler process 160. As further shown, profiler orchestrator process 150 includes a profile mapping 410. The illustrated embodiment may be implemented differently than shown. For example, profile orchestrator process 150 may not receive an end request 330 to terminate performance profiler process 160.

As shown, profiler orchestrator process 150 receives a start request 320, which can be received from a backend process 142 to profile the execution of a database statement 110. In response to receiving start request 320, profiler orchestrator process 150 may extract information from start request 320, such as the statement ID of the database statement 110, a backend ID of the backend process 142 assigned by database engine 140, a process ID of the backend process 142 assigned by an operating system associated with system 100, and/or a profile duration 234, in order to manage the profiling session for that backend process 142. For example, profiler orchestrator process 150 may extract the process ID of the backend process 142 assigned by an operating system in order to map the profiling session to that backend process 142.

In various embodiments, profiler orchestrator process 150 performs a fork operation to spawn performance profiler process 160. Profile orchestrator process 150 may assign a unique identifier to performance profiler process 160 as part of creating profile mapping 410. Profile mapping 410, in various embodiments, is a mapping that maps performance profiler processes 160 to backend processes 142. For example, a key-value pair of profile mapping 410 may include the ID of performance profiler process 160 and the ID of the corresponding backend process 142. Profile mapping 410 may include additional information for managing profiler process 160, such as a profile duration 234, a rate limit 235, etc. Profile mapping 410 is discussed in greater detail with respect to FIG. 5.

After performance profiler process 160 is spawned, it may execute an execl( ) system call to replace its current process image with a new process image that allows process 160 to profile the execution of the appropriate database statement 110. Replacing the process image may include replacing the code, data, heap, and stack segments of performance profiler process 160 such that it executes program code corresponding to the Linux perf command. As part of invoking the perf command, the process ID of the backend process 142 (assigned by the operation system) may be specified with the −p option. For example, profile orchestrator process 150 may extract the process ID from the received start request 320 and provide it to performance profiler process 160 in order to execute the perf command. By executing perf with the −p option, performance profiler process 160 records performance metrics during the execution of the database statement 110 by the backend process 142 to create a performance report 170. Performance profiler process 160 may write the performance report 170 to database 120 as statement 110 executes or upon terminating. An example performance report 170 is discussed in greater detail with respect to FIG. 6.

In the illustrated embodiment, profiler orchestrator process 150 receives an end request 330 (from the particular backend process 142) to terminate performance profiler process 160. For example, the backend process 142 may send end request 330 to profiler orchestrator process 150 in response to completing the execution of the database statement 110. End request 330 may include the ID of the backend process 142 assigned by database engine 140, the ID of the backend process 142 assigned by an operating system, and/or the ID of the database statement 110 such that profiler orchestrator process 150 may identify performance profiler process 160 based on profile mapping 410. For example, profiler orchestrator process 150 may identify which performance profiler process 160 to terminate based on the ID of the backend process 142 assigned by database engine 140 or the ID assigned by the operating system. In response to receiving end request 330, in various embodiments, profiler orchestrator process 150 identifies the appropriate performance profiler process 160 associated with end request 330 based on profile mapping 410 and issues a kill (SIGINT) system call to terminate it. Prior to terminating, performance profiler process 160 finishes writing a performance report 170 to database 120.

In some embodiments, profiler orchestrator process 150 does not receive end request 330 and terminates performance profiler process 160 based on parameters specified by of the relevant profiler configuration 230. For example, profiler orchestrator process 150 may terminate profiler process 160 based on a profile duration 234.

Turning now to FIG. 5, a block diagram illustrating an example of profiler orchestrator process 150 maintaining a map between performance profiler processes 160A-C and backend process 142A-C is shown. In the illustrated embodiment, profiler orchestrator process 150 includes profile mapping 410. As further shown, profile mapping 410 includes backend process IDs 510A-C, statement IDs 232A-C, and performance profiler process IDs 520A-C. In some embodiments, profile mapping 410 is implemented differently than shown. For example, profile mapping 410 may include process IDs of backend processes 142A-C assigned by an operating system associated with system 100.

In various embodiments, profile mapping 410 includes backend process ID 510A-C, statement ID 232A-C, and performance profiler process ID 520A-C to map performance profiler process 160A-C to backend process 142A-C, respectively. As part of creating an entry in profile mapping 410, profile orchestrator process 150 may receive a start request 320 from a backend process 142 that includes their backend process ID 510 and a statement ID 232 corresponding to the relevant database statement 110. A backend process ID 510, in various embodiments, is a unique identifier assigned to a backend process 142 by database engine 140. In some embodiments, a start request 320 may also include parameters from a profiler configuration 230, such as a rate limit 235. Profile orchestrator process 150 extracts this information from the start request 320 to create an entry in profile mapping 410.

In response to receiving a start request 320 associated with backend process 142A for example, profile orchestrator process 150 spawns performance profiler process 160A and assigns performance profiler process ID 520A to it. A performance profiler process ID 520, in various embodiments, is a unique identifier and may be stored as a value corresponding to a key, such as backend process ID 510, in profile mapping 410. For example, profile orchestrator process 150 may identify performance profiler process 160A as associated with backend process 142A based on backend process ID 510A and performance profiler process ID 520A. In some embodiments, a performance profiler process ID 520 is stored as a key in profile mapping 410 and is used to identify information associated with a particular performance profiler process 160. The entry in profile mapping 410 for a performance profiler process 160 may be created upon that spawning performance profiler process 160.

As part of terminating the profiling session associated with backend process 142A for example, profiler orchestrator process 150 may receive an end request 330 from backend process 142A that includes backend process ID 510A and/or statement ID 232A. Profiler orchestrator process 150 may identify performance profiler process 160A as corresponding to backend process 142A based on backend process ID 510A or statement ID 232A being associated with performance profiler process ID 520A. Profiler orchestrator process 150 thus terminates performance profiler process 160A. In some embodiments, profiler orchestrator process 150 terminates performance profiler process 160A based on parameters stored with process ID 520A. For example, profiler orchestrator process 150 may determine to terminate process 160A based on a profile duration 234.

Turning now to FIG. 6, a block diagram for an example performance report 170 is shown. In the illustrated embodiment, performance report 170 includes a statement ID 232, a call stack 612, performance metrics 614, and an execution time 616. In some embodiments, performance report 170 is implemented differently than shown—e.g., performance report 170 may include additional IDs, such as a backend process ID 510, a performance profiler process ID 520, and a backend process ID.

As discussed, in various embodiments, performance report 170 includes performance data collected by a performance profiler process 160 during the execution of a particular database statement 110. Performance report 170 may be stored as a binary file (e.g., perf.data) or stored a row in a table that is accessible using statement ID 232, which specifies the particular database statement 110 corresponding to performance report 170. Performance report 170 may be read using a perf report command.

Call stack 612, in various embodiments, is a stack data structure that tracks function calls associated with the execution of a database statement 110. Call stack 612 may indicate an ordering in which the functions were called and metadata associated with those functions. For example, call stack 612 may identify a function call sequence made during the execution of statement 110, function names, parameters passed during a particular function call, stack pointers, etc. In some embodiments, call stack 612 is presented as a graphical representation (e.g., call graph). The graphical representation may be created using a debugging information file format, such as DWARF, to unwind call stack 612. Nodes of the graphical representation may represent functions while edges represent calls between those functions.

Performance metrics 614, in various embodiments, is a set of data associated with the execution of a database statement 110. Performance metrics 614 may include data describing memory usage (e.g., the amount of memory allocated), CPU usage (e.g., the number of CPU cycles), input/output operations (e.g., the number of disk read operations), and/or network resources. For example, performance metrics 614 may state the number of remote procedure calls made by the particular backend process 142. Performance metrics 614 may also include values of the hardware and software performance counters provided by the CPU and the operating system. In some embodiments, performance report 170 includes performance metrics 614 for one or more functions in call stack 612.

Execution time 616, in various embodiments, is the execution time of a database statement 110 and/or the execution time of function(s) in call stack 612. For example, execution time 616 may specify a total execution time for a database statement 110 and an execution time for each function in call stack 612. Execution time 616 may be represented as a percentage. For example, the percentage for a function may indicate its execution time relative to the execution times of the other functions.

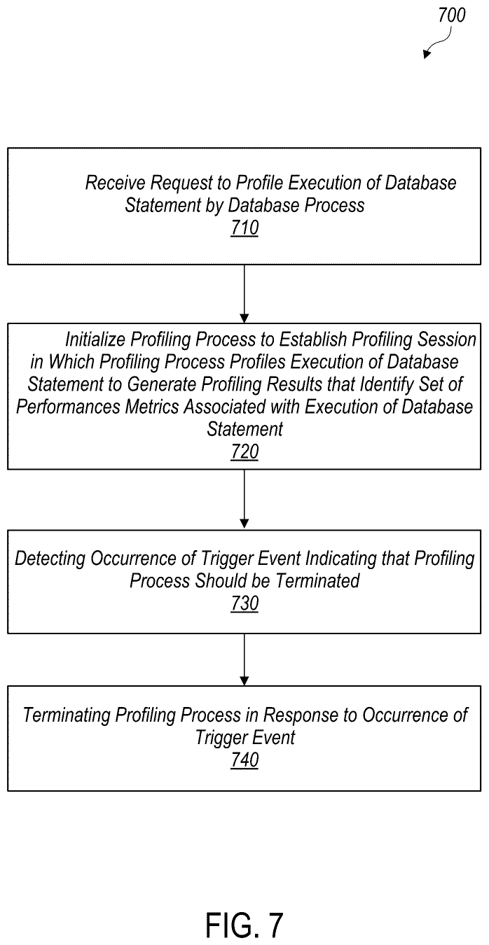

Turning now to FIG. 7, a flow diagram of a method 700 is shown. Method 700 is one embodiment of a method that is performed by a computer system (e.g., system 100) to profile an execution of a database statement (e.g., a database statement 110). Method 700 may be performed by executing a set of program instructions stored on a non-transitory computer-readable medium. Method 700 may include more or less steps than shown. As an example, method 700 may not include step 740 in which the profiling process is terminated in response to the occurrence of a trigger event.

Method 700 begins in step 710 with the computer system receiving a request (e.g., a start request 320) to profile the execution of the database statement by a database process (e.g., a backend process 142). In various embodiments, the request specifies a database process ID (e.g., an ID assigned by database engine 130 or by an operating system associated with system 100) associated with the database process. The computer system may receive a profiler configuration (e.g., a profiler configuration 230) as part of a request to start profiling subsequent executions of the database statement. The computer system may generate, based on the profiler configuration, a query execution plan (e.g., an execution plan 225) for the database statement that causes the database process to send the request to profile the execution of the database statement. In response to receiving the profiler configuration, the computer system may invalidate a previous query execution plan for the database statement to prevent the database process from executing the database statement without issuing the request to profile the execution of the database statement.

In step 720, the computer system initializes a profiling process (e.g., a performance profiler process 160) to establish a profiling session in which the profiling process profiles the execution of the database statement to generate profiling results (e.g., a performance report 170) that identify a set of performances metrics (e.g., performance metrics 614) associated with the execution of the database statement. In various embodiments, the initializing includes providing the process ID to the profiling process to allow the profiling process to establish the profiling session. The computer system may maintain a mapping (e.g., profile mapping 410) between a set of profiling processes and a set of database processes based on database process IDs (e.g., backend process IDs 510) and profiling process IDs (e.g., performance profiler process IDs 520). The initializing may include updating the mapping to map the profiling process to the database process. In various embodiments, the profiler configuration identifies a first number of executions of the database statement to profile. The computer system may initialize profiling processes in response to receiving requests from one or more database processes until a second number of executions of the database statement satisfies the first number of executions (e.g., a number of executions 233) identified by the profiler configuration. In various embodiments, the computer system receives an indication identifying a number of profiling sessions that are permitted to be active concurrently (e.g., a rate limit 235). The computer system may rate constrains initialization of profiling processes based on the number of profiling sessions that are permitted to be active concurrently.

In step 730, the computer system detects an occurrence of a trigger event indicating that the profiling process should be terminated. The computer may receive an indication that specifies a time duration (e.g., a profile duration 234) for how long the profiling session is to be active, and the computer system may determine that the profiling session has been active for at least the time duration and thus terminate it.

In step 740, the computer system terminates the profiling process in response to the occurrence of the trigger event. In various embodiments, the profiling results are stored in a storage repository (e.g., database 120) accessible to the computer system. In various embodiments, the computer system receives, subsequent to the execution of the database statement by the database process, a termination request (e.g., an end request 530) from the database process to terminate the profiling session, and the terminating may be based on the termination request. In response to the occurrence of the trigger event, the computer system may identify, based on information associated with the trigger event, the profiling process from the set of profiling processes of the mapping to terminate. In various embodiments, the profiling results include a call stack (e.g., a call stack 612) identifying a plurality of functions executed during the execution of the database statement and one or more execution times (e.g., execution times 616) associated with the plurality of functions. The terminating may include issuing a termination request to the profiling process to terminate. In various embodiments, the profiling process is operable to write the profiling results to the storage repository in response to receiving the termination request.

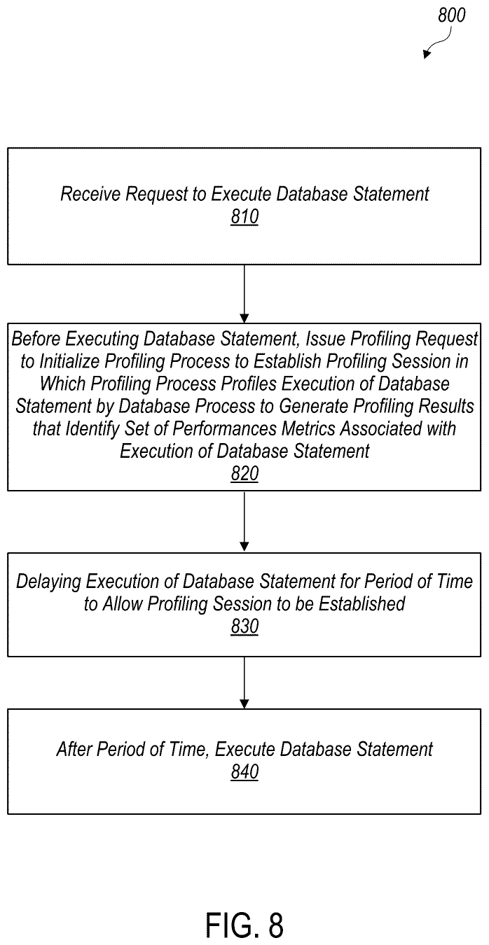

Turning now to FIG. 8, a flow diagram of a method 800 is shown. Method 800 is one embodiment of a method performed by a backend process (e.g., a backend process 142) to profile the execution of a database statement (e.g., a database statement 110) by the database processes. Method 800 may be performed by executing a set of program instructions stored on a non-transitory computer-readable medium. Method 800 may include more or less steps than shown. As an example, method 800 may not include step 820 in which the execution of the database statement is delayed.

Method 800 begins in step 810 with the backend process receiving a request to execute a database statement. In step 820, before executing the database statement, the backend process issues a profiling request (e.g., a start request 320) to initialize a profiling process (e.g., a performance profiler process 160) to establish a profiling session in which the profiling process profiles the execution of the database statement by the database process to generate profiling results (e.g., a performance report 170) that identify a set of performances metrics (e.g., performance metrics 614) associated with the execution of the database statement. In various embodiments, the profiling request includes a process ID (e.g., an ID assigned by database engine 130 or by an operating system associated with system 100) associated with the database process that allows the profiling process to establish the profiling session. In various embodiments, the profiling request is sent to a profile orchestrator process (e.g., profiler orchestrator process 150) that is operable to spawn the profiling process as a child process of the profile orchestrator process. In various embodiments, the profiling request includes a database statement ID (e.g., a statement ID 232) associated with the database statement and an indication of a time duration (e.g., a profile duration 234) for how long the profiling session is to be active.

In step 830, the backend process delays the execution of the database statement for a period of time to allow the profiling session to be established. In step 840, after the period of time, the backend process executes the database statement. In various embodiments, the profiling results associated with the execution of the database statement are stored in a storage repository (e.g., database 120) accessible to the computer system that is executing the backend process. After executing the database statement, the backend process, in various embodiments, issues a termination request (e.g., an end request 530) to terminate the profiling process. The termination request may include the process ID associated with the database process.

### Exemplary Computer System

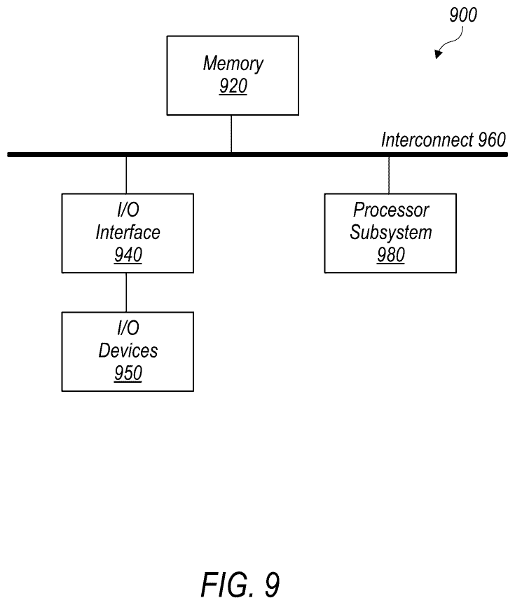

Turning now to FIG. 9, a block diagram of an exemplary computer system 900, which may implement system 100, database 120, and/or database node 130, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In various embodiments, program instructions that when executed implement database engine 140, backend processes 142, profiler orchestrator processes 150, and/or performance profiler processes 160 may be included/stored within system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over Wifi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

1. A method for profiling an execution of a database statement, the method comprising:
receiving, by a computer system and from a database process before the database process executes the database statement, a request to profile the execution of the database statement by the database process, wherein the request specifies a process identifier (ID) of the database process;
initializing, by the computer system, a profiling process that establishes a profiling session in which the profiling process profiles the execution of the database statement and generates profiling results that identify a set of performances metrics associated with the execution of the database statement, wherein the initializing includes providing the process ID to the profiling process for establishing the profiling session, and wherein the profiling process is distinct from the database process and does not inherit state from the database process;
detecting, by the computer system, an occurrence of a trigger event indicating that the profiling process should be terminated; and
terminating, by the computer system, the profiling process in response to the occurrence of the trigger event, wherein the profiling results are stored in a storage repository accessible to the computer system.

2. The method of claim 1, wherein the detecting includes receiving, subsequent to the execution of the database statement by the database process, a termination request from the database process to terminate the profiling session, wherein the terminating is based on the termination request.

3. The method of claim 1, further comprising:
receiving, by the computer system, an indication that specifies a time duration for how long the profiling session is to be active, wherein the detecting includes determining that the profiling session has been active for at least the time duration.

4. The method of claim 1, further comprising:
maintaining, by the computer system, a mapping between a set of profiling processes and a set of database processes based on database process IDs and profiling process IDs, wherein the initializing includes updating the mapping to map the profiling process to the database process; and
in response to the occurrence of the trigger event, the computer system identifying, based on information associated with the trigger event, the profiling process from the set of profiling processes of the mapping to terminate.

5. The method of claim 1, further comprising:
receiving, by the computer system, a profiler configuration as part of a request to start profiling subsequent executions of the database statement; and
generating, by the computer system based on the profiler configuration, a query execution plan for the database statement that includes a command to send the request to profile the execution of the database statement, wherein the query execution plan is executed by the database process.

6. The method of claim 5, further comprising:
in response to receiving the profiler configuration, the computer system invalidating a previous query execution plan for the database statement to prevent the database process from executing the database statement without issuing the request to profile the execution of the database statement.

7. The method of claim 5, wherein the profiler configuration identifies a first number of executions of the database statement to profile; and wherein the method further comprises:
initializing, by the computer system, profiling processes in response to receiving requests from one or more database processes until a second number of executions of the database statement satisfies the first number of executions identified by the profiler configuration.

8. The method of claim 1, further comprising:
receiving, by the computer system, an indication identifying a number of profiling sessions that are permitted to be active concurrently; and
rate constraining, by the computer system, initialization of profiling processes based on the number of profiling sessions that are permitted to be active concurrently.

9. The method of claim 1, wherein the profiling results include a call stack identifying a plurality of functions executed during the execution of the database statement and one or more execution times associated with the plurality of functions.

10. The method of claim 1, wherein the terminating includes issuing a termination request to the profiling process that causes the profiling process to write the profiling results to the storage repository and terminate.

11. A non-transitory computer-readable medium having program instructions stored thereon that are capable of causing a computer system to perform operations comprising:
receiving, from a database process before the database process executes a database statement, a request to profile an execution of the database statement by the database process, wherein the request specifies a process identifier (ID) of the database process;
initializing a profiling process that establishes a profiling session in which the profiling process profiles the execution of the database statement and generates profiling results that identify a set of performances metrics associated with the execution of the database statement, wherein the initializing includes providing the process ID to the profiling process for establishing the profiling session, and wherein the profiling process is distinct from the database process and does not inherit state from the database process;
detecting an occurrence of a trigger event indicating that the profiling process should be terminated; and
terminating the profiling process in response the occurrence of the trigger event, wherein the profiling results are stored in a storage repository accessible to the computer system.

12. The non-transitory computer-readable medium of claim 11, wherein the detecting includes receiving, subsequent to the execution of the database statement by the database process, a termination request from the database process to terminate the profiling session, wherein the terminating is based on the termination request.

13. The non-transitory computer-readable medium of claim 11, wherein the operations further comprise:
maintaining a mapping between a set of profiling processes and a set of database processes based on database process IDs and profiling process IDs, wherein the initializing includes updating the mapping to map the profiling process to the database process; and
in response to the occurrence of the trigger event, identifying, based on information associated with the trigger event, the profiling process from the set of profiling processes of the mapping to terminate.

14. The non-transitory computer-readable medium of claim 11, wherein the operations further comprise:
receiving a profiler configuration as part of a request to start profiling subsequent executions of the database statement; and
based on the profiler configuration, generating a query execution plan for the database statement that includes a command to send the request to profile the execution of the database statement, wherein the query execution plan is executed by the database process.

15. The non-transitory computer readable medium of claim 14, wherein the operations further comprise:
in response to receiving the profiler configuration, invalidating a previous query execution plan for the database statement to prevent the database process from executing the database statement without issuing the request to profile the execution of the database statement.

16. The non-transitory computer-readable medium of claim 11, wherein the operations further comprise:
receiving an indication identifying a number of profiling sessions that are permitted to be active concurrently; and
rate constraining initialization of profiling processes based on the number of profiling sessions that are permitted to be active concurrently.

17. A non-transitory computer-readable medium having program instructions stored thereon that are capable of causing a computer system to implement a database process that perform operations comprising:
receiving a request to execute a database statement;
before executing the database statement, issuing a profiling request that initializes a profiling process that establishes a profiling session in which the profiling process profiles the execution of the database statement by the database process and generates profiling results that identify a set of performances metrics associated with the execution of the database statement, wherein the profiling request includes a process identifier (ID) of the database process that allows the profiling process to establish the profiling session, and wherein the profiling process is distinct from the database process and does not inherit state from the database process;
delaying the execution of the database statement for a period of time to allow the profiling session to be established; and
after the period of time, executing the database statement, wherein the profiling results associated with the execution of the database statement are stored in a storage repository accessible to the computer system.

18. The non-transitory computer-readable medium of claim 17, wherein the operations further comprise:
after executing the database statement, issuing a termination request to terminate the profiling process, wherein the termination request includes the process ID of the database process.

19. The non-transitory computer-readable medium of claim 17, wherein the profiling request is sent to a profile orchestrator process that spawns the profiling process as a child process of the profile orchestrator process.

20. The non-transitory computer readable medium of claim 17, wherein the profiling request includes a database statement ID associated with the database statement and an indication of a time duration for how long the profiling session is to be active.
